(19) United States
(12) Patent Application Publication
(10) Pub. No.: US 2015/0013823 A1
(43) Pub. Date: Jan. 15, 2015

(54) Dispensing Device For Maintaining Carbonation In Container

(71) Applicant: Thomas J. Vokac, Naperville, IL (US)

(72) Inventor: Thomas J. Vokac, Naperville, IL (US)

(21) Appl. No.: 14/158,007

(22) Filed: Jan. 17, 2014

Related U.S. Application Data
(60) Provisional application No. 61/806,243, filed on Mar. 28, 2013.
(60) Provisional application No. 61/818,672, filed on May 2, 2013.

(51) Int. Cl. B67D 7/36; B67D 7/02

(52) U.S. Cl. CPC B67D 7/36; B67D 7/02
USPC 141/1; 222/545

(57) ABSTRACT

A dispensing device for dispensing carbonated beverage from a bottle having a screw-on cap, includes a body having a cap-engaging aperture, the cap-engaging aperture having able to engage the screw-on cap of the bottle to unscrew the cap in a bottle-inverted orientation for dispensing. According to one embodiment, the body comprises a concave member with a concave side and a convex side and having the cap-engaging aperture in a central region thereof, the concave side providing a collection area for beverage dispensed from the bottle and the concave member having at least one through opening for draining the beverage from the curved member. An alternate embodiment provides a handled dispensing device. A further embodiment provides a concave member that is formed with or fixed to the bottle cap.

This application claims the benefit of U.S. Provisional Application 61/806,243, filed Mar. 28, 2013, and U.S. Provisional Application 61/818,672, filed May 2, 2013.

### BACKGROUND

Carbonated beverages are desirable because CO₂ enhances the taste of the beverage. During typical dispensing of a carbonated beverage, when the cap is removed the carbonated headspace above the beverage within the container is released to the atmosphere and the equalized pressure in the carbonated beverage also releases carbonation to the atmosphere. After each use, the bottle is recapped and some of the carbonation from the beverage equalizes with the pressure in the headspace above the liquid. Each time the bottle is opened, more CO₂ is released from the bottle before the beverage is dispensed into a glass.

After repeated uses, the CO₂ pressure in the remaining beverage is reduced to zero or near zero and, in the beverage industry term, the beverage goes flat. It is not desirable to utilize flat or nearly flat carbonated beverages which are typically discarded.

The present inventor has recognized the desirability of providing a method and device for prolonging the carbonation of beverages contained in bottles where the bottles must be opened to dispense the beverage into a glass or the like.

### SUMMARY

The invention provides a dispensing device for dispensing carbonated beverage from a bottle having a screw-on cap that can include a body having a cap-engaging aperture, the cap-engaging aperture able to engage the screw-on cap of the bottle to unscrew the cap in a bottle-inverted orientation for dispensing. A shroud or other body is provided to direct the dispensed beverage into a glass located below the device.

The invention provides a method of dispensing carbonated beverage from a bottle into a glass that includes the steps of:

providing a dispensing device that includes a cap-engaging aperture for receiving a bottle cap that seals the bottle;

engaging the bottle cap with the cap-engaging aperture;

holding the bottle inverted over a glass;

relatively rotating the dispensing device and cap with respect to the bottle to loosen the seal between the bottle and cap and dispensing beverage through the seal and into the glass.

Further steps include providing a collection area in the dispensing device and providing a drain opening from the collection area into the glass; and

during dispensing, collecting beverage within the collecting area and draining the beverage into the glass through the drain opening.

The invention provides a simple way to dispense carbonated beverages from bottles to the user's glass or other vessel. This invention avoids the typical loss of carbonation from the beverage remaining in the bottle.

One embodiment of the device is similar in shape to a nut cracker. The device is placed on top of the vessel or glass to be filled. A hole in the end of the device is sized to match the diameter of the outside of the bottle cap. The bottle is turned upside down and the cap inserted into the hole at the end of the on top of the glass. In this configuration, liquid will be dispensed from the bottle while maintaining the pressurized headspace in the bottle. The perimeter outside of the receiving hole for the bottle cap is perforated with holes that allow the liquid to dispense into the glass. A small shroud outside of the dispensing hole pattern forms a small reservoir and allows the liquid to flow into the glass. Two legs protrude back from the head of the device to act like handles. By squeezing the handles, as like a nut cracker motion, the bottle cap is engaged by the invention. The next step involves rotating the bottle relative to the bottle cap. The rotation is limited to weakening but not totally breaking the seal between the bottle and the bottle cap. A measured amount of liquid will flow through the partially opened seal between the bottle and the cap. When the squeeze on the arms is removed, a controlled volume of beverage is dispensed into the glass. Upon adequately filling the glass, the arms are re-squeezed and the bottle is counter rotated, resealing the cap.

Another embodiment of the invention provides a device similar in shape to a large lens. The device is placed on top of the vessel or glass to be filled. A hole in the center of the device is sized to match the diameter of the outside of the bottle cap. The bottle to be tapped is turned upside down and the cap inserted into the hole at the center of the invention. In this configuration, liquid will be dispensed from the bottle while maintaining the pressurized headspace in the bottle. The perimeter outside of the receiving hole for the bottle cap is perforated with holes or slots that allow the liquid to dispense into the glass. The next step involves rotating the bottle relative to the bottle cap. A measured amount of liquid will flow through the partially opened seal between the bottle and the cap. The dispensed liquid will temporarily collect in the reservoir provided by the shape of the invention and then flow through the holes provided around the outside of the cap. Upon adequately filling the glass, the bottle is counter rotated, resealing the cap.

A further embodiment of the invention is similar to the second embodiment except that the device is permanently associated with the bottle cap. By producing a bottle cap with the dispensing device integral therewith, the dispensing device can be rotated to open the bottle while inverted onto a glass, beverage in the bottle can be dispensed into the glass, and the device can be counter-rotated to re-close the bottle.

The embodiments of the invention provide the ability to maintain carbonation in an opened bottle for an extended time. There is a tendency for the consumer that does not consume the volume of a two liter container in a reasonable amount of time, before the beverage goes flat, to purchase the smaller and more expensive 12 ounce containers. Thus, there is a cost savings benefit. An additional benefit is realized because some difficulty is experienced by handicap or elderly people while opening a container. The devices assist in opening the cap similar to the jar opening tool.

Numerous other advantages and features of the present invention will become readily apparent from the following detailed description of the invention and the embodiments thereof, from the claims and from the accompanying drawings.

### BRIEF DESCRIPTION OF THE DRAWINGS

FIG. 1 is a perspective view of a dispensing device according to the invention;

FIG. 2 is a fragmentary perspective view of the device of FIG. 1 shown in operation dispensing a beverage from a bottle into a glass;

FIG. 3 is a perspective view of a second embodiment dispensing device according to the invention;

FIG. 4 is a bottom view of the device of FIG. 3;

FIG. 5 is a top view of the device of FIG. 3:

FIG. 6 is a side view of the device of FIG. 3;

FIG. 7 is an enlarged view taken from FIG. 6:

FIG. 8 is an enlarged view taken from FIG. 5;

FIG. 9 is a perspective inside view of the device of FIG. 3;

FIG. 10 is an enlarged perspective view taken from FIG. 9;

FIG. 11 is a fragmentary perspective view of the dispensing device of FIG. 3 shown in operation dispensing a beverage from a bottle into a glass;

FIG. 12 is a perspective view of a alternate embodiments of the dispensing device shown in FIG. 3;

FIG. 13 is a perspective view of a further embodiment of a dispensing device that is integrated with a bottle cap;

FIG. 14 is a sectional view of the dispensing device of FIG. 13 mounted on a bottle;

FIG. 15 is a perspective bottom view of a further embodiment dispensing device according to the invention;

FIG. 16 is a perspective top view of the embodiment of FIG. 15;

FIG. 17 is a side view of the embodiment of FIG. 15;

FIG. 18 is a top view of the embodiment of FIG. 15:

FIG. 19 is a sectional view taken along line 19-19 of FIG. 18; and

FIG. 20 is an enlarged view of a portion of FIG. 17.

### DETAILED DESCRIPTION

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

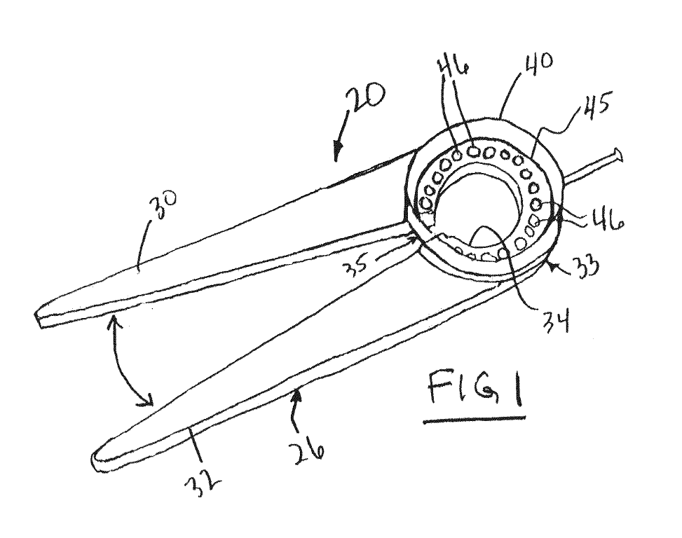

FIG. 1 illustrates a first embodiment of the invention. A dispensing device 20 comprises of two components, the first component being a main body 26 with arms 30, 32 connected to a head 33. The head includes a central hole 34 with a slot 35 between the arms. Squeezing the arms together resiliently decreases the width of the slot 35 and the diameter of the hole 34. The second component is a shroud 40 being a cylindrical thin walled element. The main body 26 resembles a nut cracker shape. The shroud 40 is attachable to the head 33. The main head 33 has a narrow circular groove 45 running outside of a plurality of drain holes 46 that surround the central hole 34. The shroud 40 is inserted in the groove 45. The main body and the shroud can be composed of plastic and manufactured by injection molding.

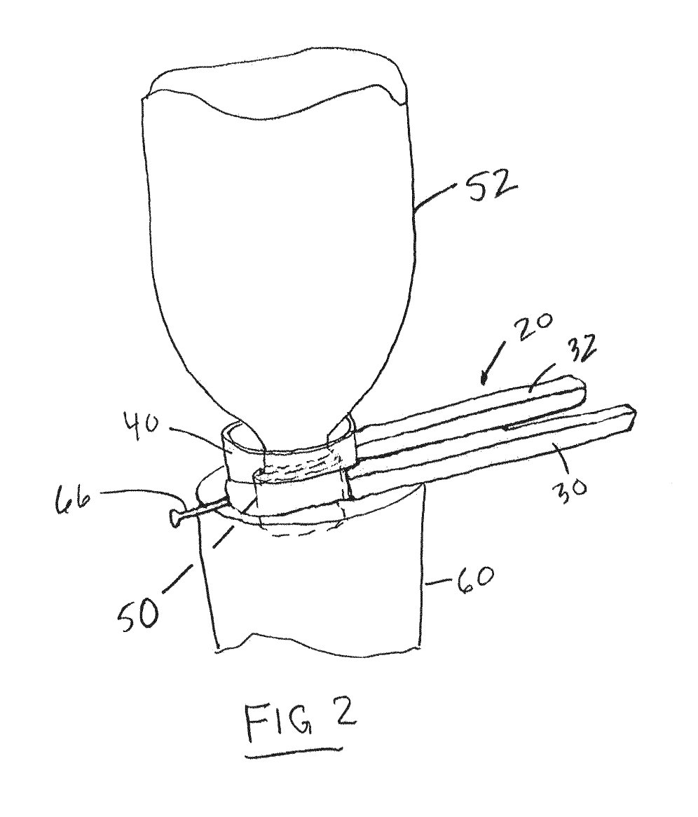

FIG. 2 shows the invention in its operational configuration showing the bottle 52, the dispensing device 20, and the receiving vessel, the glass 60.

The device 20 is positioned on top of the receiving vessel, glass or cup 60 that will receive the dispensed carbonated beverage. A pin 66 can be fit into the head 33 to help support the device 20 onto the glass 60. The carbonated beverage container is inverted and the container cap is inserted into the central hole 34. One hand of the operator clasps the two arms 30, 32 while the second hand clasps the top of the carbonated beverage bottle 52. A first hand squeezes the arms 30, 32 to grasp or engage the cap 50 with adequate friction to prevent relative rotation between the head 33 and the cap 50. The second hand then rotates the bottle slightly to begin dispensing the liquid. The first hand releases the squeeze on the arms which allows the liquid to flow into the reservoir provided by the shroud 40 through the drain holes 46 and into the vessel 60. Upon adequate dispensing of the liquid into the vessel, the first hand re-squeezes the arms 30, 32 and the bottle cap and counter rotates the bottle to tighten the cap onto the bottle. The bottle and device 20 are then removed from the top of the vessel 60.

The use of the inverted bottle only allows liquid to be dispensed while maintaining the CO₂ pressurized headspace in the bottle.

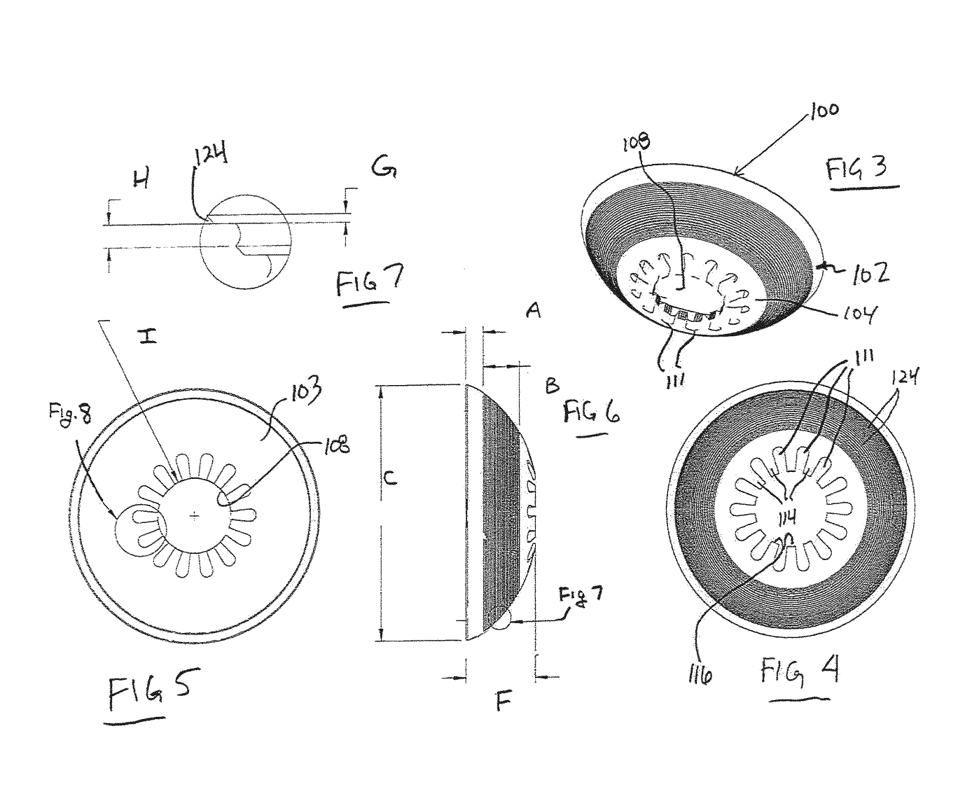

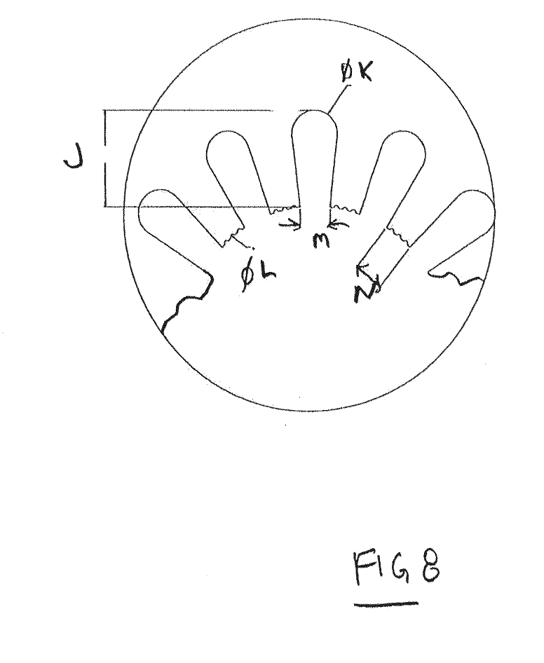

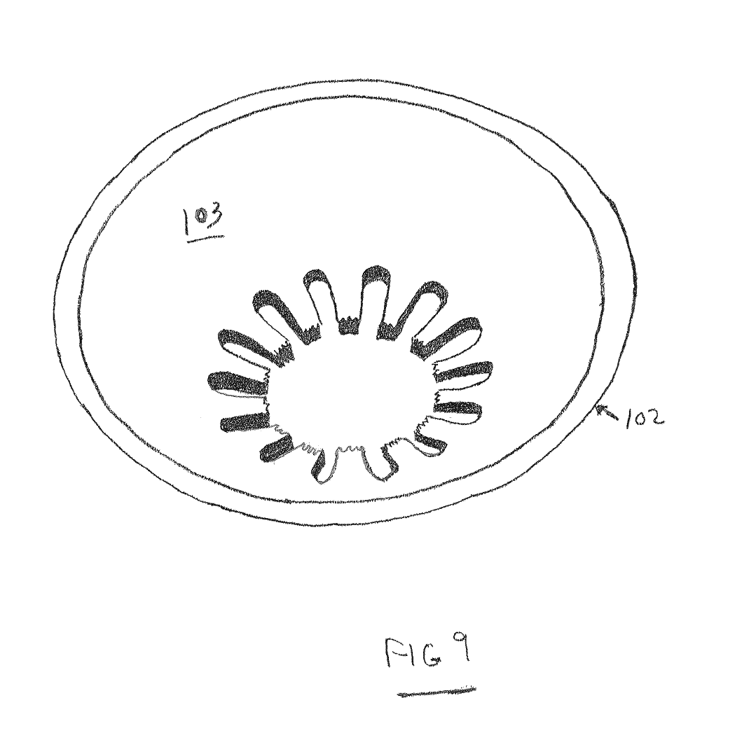

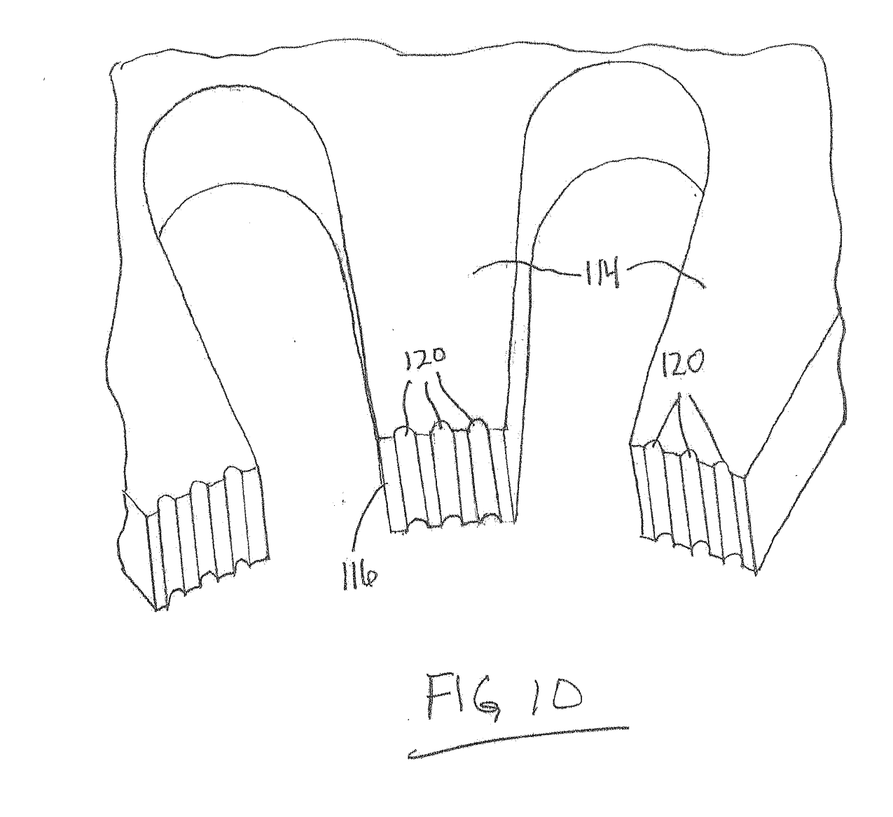

FIGS. 3-11 illustrate a second embodiment of the invention. This device 100 is similar in shape to a large lens, such as the shape of a contact lens. The device 100 includes a concave body such as a curved body 102 to be placed on top of the vessel or glass 60 to be filled. The curved body includes a concave top side 103 and a convex bottom side 104. A hole 108 in the center of the body 102 is sized to match the diameter of the outside of the bottle cap 50. The bottle 52 to be drained is turned upside down and the cap 50 inserted into the hole 108 at the center of the body. The hole 108 includes provisions to engage the bottle cap. A perimeter outside of the receiving hole 108 for the bottle cap is perforated with drain slots 111 or holes that allow the liquid to drain into the glass.

The slots 111 are open into the center hole 108. The slots 111 define fingers 114 between adjacent slots. Each finger 114 provides a rectangular surface 116 facing toward a center of the hole 108. There are three parallel, vertical grooves 120 on each rectangular surface 116 that extend from a top of the surface 116 to a bottom of the surface 116. The vertical grooves are complementary to the ribs present on the bottle cap. When the bottle cap is fit into the hole 108, at least some of the ribs of the bottle cap mesh with the grooves 120 of the body 102 to fix the bottle cap 50 to the body 102 to prevent relative rotation between the cap 50 and the body 102. Alternatively to the grooves 120, the hole 108 can be configured and shaped to resiliently grip the bottle cap to prevent relative rotation therebetween, or the hole 108 can be configured to have teeth to engage the bottle cap 50 to prevent relative rotation therebetween.

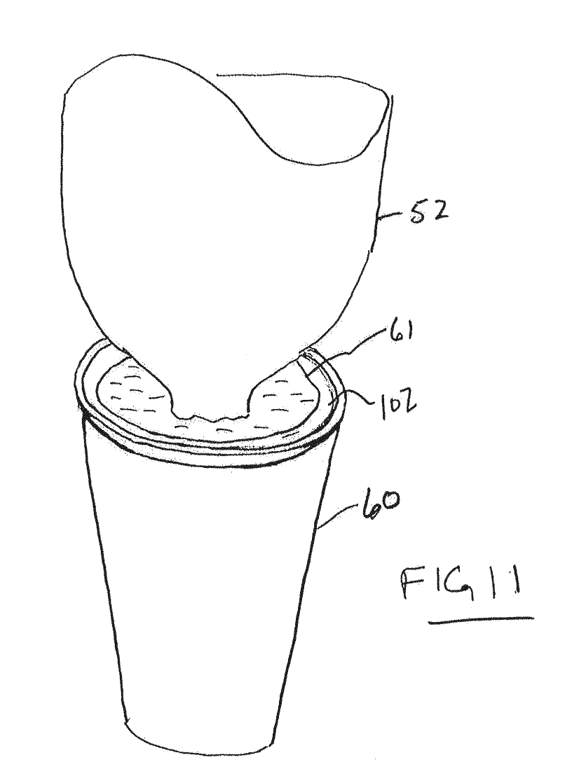

The bottle 52 (FIG. 11) is then rotated relative to the body 102 while the bottle cap 50 is held by the body 102 to prevent relative rotation with respect to the body 102. The bottle cap ribs are engaged into the vertical grooves 120 to lock the bottle cap to the body to prevent relative rotation between the body 102 and the cap 50. The rotation direction of the bottle 52 with respect to the body 102 is to loosen the seal between the bottle and the bottle cap. A measured amount of liquid will flow through the partially opened seal between the bottle and the cap. The dispensed liquid will temporarily collect in a reservoir provided by the concave top side 103 of the curved body 102 and then flow through the slots 111 provided around the outside of the cap. Upon adequately filling the glass, the bottle is counter rotated, resealing the cap.

A benefit from use of the embodiments is the ability to maintain carbonation in an opened or almost opened bottle for an extended time.

The hole 108 can be sized to receive the cap of a one or two liter carbonated beverage bottle, or the like. A typical bottle cap is tapered from 1.210 inches diameter at the bottom to 1.165 inches diameter at the top. An advantageous clear diameter for the hole 108 can be about 1.185 inches, measured diametrically between rectangular surface 116. The body 102 can be approximately ¼ of an inch thick. When the bottle cap is inserted into the hole, the bottom of the body can be flush with the top of the cap.

The back half of each slot 111 is one half of a 0.20 inch diameter hole centered on a 1.8 inch diameter circle. The sides of each slot are on a radius from the center of the body 102.

The general shape of the body 102 is similar to a 4 inch diameter contact lens. The shape is a section of an ELLIPSOID. The major horizontal axis is 4.2 inches across. The minor vertical axis is 3.2 inches across. The center of the ellipse is 0.4 inches above the top surface of the body 102. The upper edge of the body 102 has a 0.03 inch radius on the inside and outside.

Annular ridges 124 are provided on the convex side 104 of the body 102 to help stabilize the body 102 onto the glass 60. The ridges help to prevent the body 102 from sliding around on top of the glass. Various size glasses will nest into one of a multitude of ridges 124. Each ridge can be approximately 0.025 inches deep and 0.050 inches wide. The first ridge begins at 0.3 inches below the upper surface of body 102 and last ridge ends one quarter of an inch from the back of the slots on the center hole. There can be approximately 24 ridges or groves.

Advantageous dimensions as shown on the drawings (in inches) are:

A=0.289; B=0.592; C=4.049; F=1.135; G=0.007; H=0.018; I (diameter)=1.185; J=0.411; K (diameter)=0.200; L (diameter)=0.201; M=0.132; N=1.336

FIG. 11 shows the body 102 placed onto a glass 60 during beverage dispensing from the bottle 52. A pool 61 of beverage fills a portion of the concave side 102 of the body 102 and drains through the slots 111 into the glass 60.

A third embodiment 100′ is shown in FIG. 12. This embodiment describes a body 102′ that is identical to the third embodiment except that the slots or holes 111′ are staggered in length away from the central hole 108.

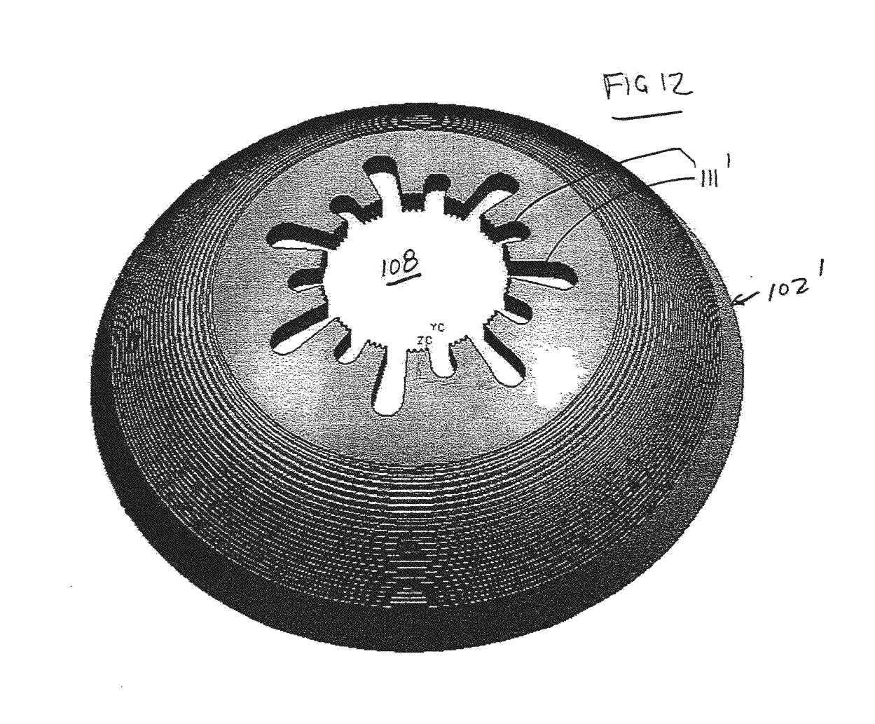

A fourth embodiment is shown in FIGS. 13 and 14. In this embodiment, the devices 100, 100′ or 300 described herein can be modified to be permanently affixed to, or formed with, the bottle cap, as opposed to being a separate bottle-opening device. Accordingly, a modified dispensing device 200 includes a lens shaped body 201 formed with a cylindrical bottle cap 202 having inside threads 204 to screw on to a bottle. A seal can be provided inside the cap. A plurality of drain holes 210 or slots surround the cap to drain dispensed beverage that accumulates in the body 201 during dispensing. The device 200 is shown screwed onto a bottle 52 in FIG. 14. The other features of the devices 100, 100′ or 300, such as the annular ridges to nest onto beverage glasses, can be incorporated into the modified dispensing device 200.

The device 200 can be sold with the bottle filled with carbonated beverage. It can be manufactured at low cost and discarded with the empty bottle.

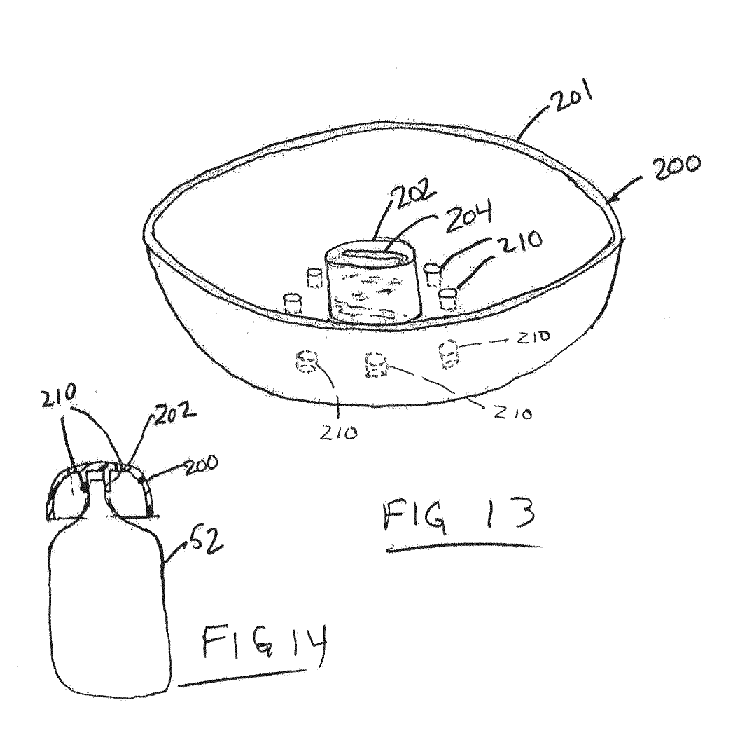

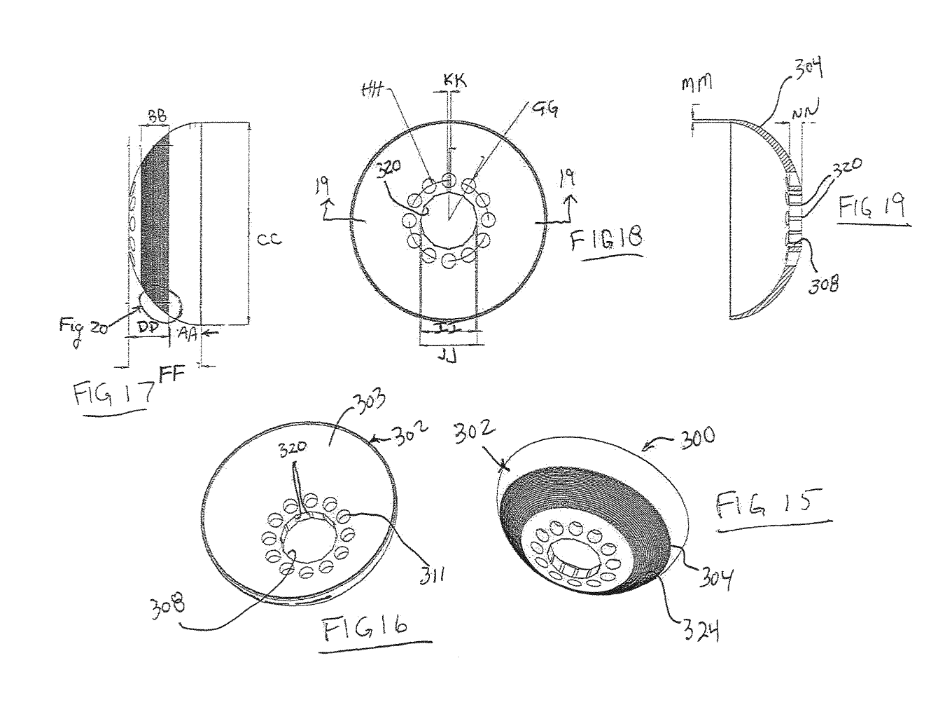

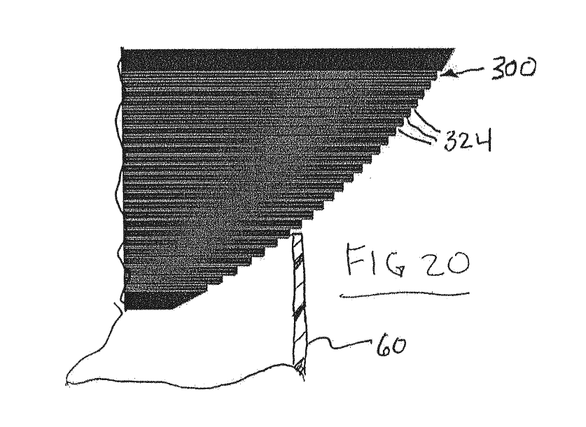

FIGS. 15-20 illustrate a further embodiment of the invention. This device 300 is similar in shape to a large lens, such as the shape of a contact lens. The device 300 includes a concave body such as a curved body 302 to be placed on top of the vessel or glass 60 to be filled. The curved body includes a concave top side 303 and a convex bottom side 304. A hole 308 in the center of the body 302 can be sized to match the diameter of the outside of the bottle cap 50 of a typical one or two liter carbonated beverage bottle, or the like. The bottle 52 to be drained is turned upside down and the cap 50 inserted into the hole 308 at the center of the body. The hole 308 includes provisions to engage the bottle cap to prevent relative rotation between the body 302 and the cap 50. A perimeter outside of the receiving hole 308 for the bottle cap is perforated with drain holes 311 that allow the liquid to drain from the concave top side 303 into the glass.

The center hole 308 provides vertical grooves 320 that extend from the concave surface 303 to the convex surface 304. The vertical grooves are complementary to the ribs present on the bottle cap. When the bottle cap is fit into the hole 308, at least some of the ribs of the bottle cap mesh with the grooves 320 of the body 302 to fix the bottle cap 50 to the body 302 to prevent relative rotation between the cap 50 and the body 302. Alternatively to the grooves 320, the hole 308 can be configured and shaped to resiliently grip the bottle cap to prevent relative rotation therebetween, or the hole 308 can be configured to have teeth to engage the bottle cap 50 to prevent relative rotation therebetween.

The bottle 52 is then rotated relative to the body 302 while the bottle cap 50 is held by the body 302 to prevent relative rotation of the cap 50 with respect to the body 302. The rotation direction is to loosen the seal between the bottle and the bottle cap. A controlled amount of liquid will flow through the partially opened seal between the bottle and the cap. The dispensed liquid will temporarily collect in a reservoir provided by the concave top side 303 of the curved body 302 and then flow through the holes 311 provided around the outside of the cap. Upon adequately filling the glass, the bottle is counter rotated with respect to the body 302, resealing the cap.

A benefit from use of the embodiments is the ability to maintain carbonation in an opened or almost opened bottle for an extended time.

The general shape of the body 302 is similar to a 4 inch diameter “contact lens.” The shape is a section of an ELLIPSOID as per the embodiments of FIGS. 3-11.

Annular ridges 324 are provided on the convex side 304 of the body 302 to help stabilize the body 132 onto the glass 60. The ridges help to prevent the body 302 from sliding around on top of the glass. Various size glasses will nest in one of a multitude of ridges 324. Each ridge should be approximately 0.025 inches deep and 0.050 inches wide. There will be approximately 24 ridges or groves.

Advantageous dimensions as shown on the drawings (in inches) are:

AA=0.7; BB=0.6; CC=4.2; DD=0.85; FF=1.84; GG (diameter)=0.30; HH (diameter)=1.69; II=1.16; JJ=1.22; KK=0.07; MM=0.06; NN=0.27.

Advantageously, the body 102 or 102′ or 201 or 302 can be formed from clear FDA approved polycarbonate or other plastic material.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. A dispensing device for dispensing carbonated beverage from a bottle having a screw-on cap, comprising:
a body having a cap-engaging aperture, the cap-engaging aperture able to engage the screw-on cap of the bottle to unscrew the cap in a bottle-inverted orientation for dispensing.

2. The dispensing device according to claim 1, wherein the body comprises a concave member with a concave side and a convex side and having the cap-engaging aperture in a central region thereof, the concave side providing a collection area for beverage dispensed from the bottle and the concave member having at least one through opening for draining the beverage from the concave member.

3. The dispensing device according to claim 2, wherein the concave member is shaped as a partial ellipsoid.

4. The dispensing device according to claim 2, wherein the body includes ridges on the convex side of the curved member.

5. The dispensing device according to claim 2, wherein the cap-engaging aperture is at least partially defined by grooves that engage the bottle cap.

6. The dispensing device according to claim 2, wherein the at least one through opening comprises a plurality of slots that extend radially outward from the cap-engaging aperture and extend through the concave member.

7. The dispensing device according to claim 2, wherein the at least one through opening comprises a plurality of holes that are arranged around the cap-engaging aperture and extend through the concave member.

8. The dispensing device according to claim 1, wherein the body comprises a concave member with a concave side and a convex side and having the cap-engaging aperture in a central region thereof, the concave side providing a collection area for beverage dispensed from the bottle;
wherein the body includes ridges on the convex side of the concave member;
wherein the cap-engaging aperture is at least partially defined by grooves that engage the bottle cap;
wherein the concave member has a plurality of holes arranged around the cap-engaging aperture and extend through the concave member for draining the beverage from the concave member.

9. The dispensing device according to claim 1, wherein the body comprises a head portion with a cap-engaging aperture, and two handle portions that when squeezed together reduce the open area of the cap-engaging aperture to engage a cap for forcible rotation with respect to the bottle.

10. The dispensing device according to claim 9, comprising a shroud for directing carbonated beverage into the glass.

11. A method of dispensing carbonated beverage from a bottle into a glass comprising the steps of:
providing a dispensing device that includes a cap-engaging aperture for receiving a bottle cap that seals the bottle;
engaging the bottle cap with the cap-engaging aperture;
holding the bottle inverted over a glass;
relatively rotating the dispensing device and cap with respect to the bottle to loosen the seal between the bottle and cap and dispensing beverage through the seal and into the glass.

12. The method according to claim 11, comprising the further step of providing a collection area in the dispensing device and providing a drain opening from the collection area into the glass; and
during dispensing, collecting beverage within the collecting area and draining the beverage into the glass through the drain opening.

13. A dispensing device for dispensing carbonated beverage from a bottle, comprising:
a screw-on cap portion having a cap shape and an internal thread for closing a bottle opening;
a body extending from the cap portion;
the body comprising a concave member with a concave side and a convex side, the concave side providing a collection area for beverage dispensed from the bottle, and the concave member having at least one through opening for draining the beverage from the concave member.

14. The dispensing device according to claim 13, wherein the concave member is shaped as a partial ellipsoid.

15. The dispensing device according to claim 13, wherein the body includes ridges on the convex side of the curved member.

16. The dispensing device according to claim 13, wherein the at least one through opening comprises a plurality of holes that are arranged around the cap-engaging aperture and extend through the concave member.
